(19) United States
(12) Patent Application Publication
(10) Pub. No.: US 2017/0235608 A1
(43) Pub. Date: Aug. 17, 2017

(54) AUTOMATIC RESPONSE TO INEFFICIENT JOBS IN DATA PROCESSING CLUSTERS

(71) Applicant: LinkedIn Corporation, Mountain View, CA (US)

(72) Inventors: Zhenyun Zhuang, Belmont, CA (US); Christopher M. Coleman, South San Francisco, CA (US); Angela Andong Deng, Mountain View, CA (US); Cuong H. Tran, Los Altos, CA (US); Hans G. Granqvist, San Jose, CA (US); Haricharan K. Ramachandra, Fremont, CA (US); Badrinath K. Sridharan, Saratoga, CA (US)

(73) Assignee: LinkedIn Corporation, Mountain View, CA (US)

(21) Appl. No.: 15/045,060

(22) Filed: Feb. 16, 2016

(51) Int. Cl. G06F 9/50

(52) U.S. Cl. CPC G06F 9/5016; G06F 9/5033

(57) ABSTRACT

The disclosed embodiments provide a method, apparatus, and system for obtaining user ratings and/or feedback for a software application. During operation, for each of a plurality of jobs executed by a computing system component, wherein each job includes an execution of a corresponding job definition: the system retrieves metadata about the job from the computing system component and calculates an inefficiency metric for the job based on the metadata, wherein a higher inefficiency metric corresponds to a more inefficient job. Next, the system ranks the plurality of jobs based on each job's inefficiency metric and selects one or more top-ranked jobs from the ranking. The system then selects one or more job definitions corresponding to the one or more top-ranked jobs. Next, the system sends optimization requests to users associated with the selected job definitions.

### BACKGROUND

Field

The disclosed embodiments relate to data processing clusters. More specifically, the disclosed embodiments relate to techniques for improving data processing cluster throughput by automatically addressing inefficient jobs that are submitted to the data processing cluster.

Related Art

To process large amounts of data, a software company may employ a software framework that can process large data sets by distributing the work as jobs across clusters of computers. These clusters typically consist of thousands of machines and, thus, may represent a major portion of the software company's business operation cost. Because the software framework may process numerous types of data sets, the jobs that are distributed amongst the clusters are inherently heterogeneous and dynamic. In some cases, sub-optimal configurations may cause certain jobs to be inefficient, which may result in cluster resources being underutilized. If a job is sub-optimally configured, it may execute inefficiently, thereby blocking the execution of other jobs, increasing the cluster's latency, and reducing the cluster's throughput.

Hence, what is needed is a system that preserves and/or improves job latency/throughput within a software framework by addressing sub-optimal job configurations within the software framework.

### BRIEF DESCRIPTION OF THE FIGURES

FIG. 1 shows a schematic of a system in accordance with the disclosed embodiments.

FIG. 2A shows a graph that illustrates a relationship between users and jobs submitted by the users in accordance with the disclosed embodiments.

FIG. 2B shows a graph that illustrates a relationship between job definitions and their corresponding jobs in accordance with the disclosed embodiments.

FIG. 3A shows a flowchart illustrating an exemplary process of automatically addressing inefficient job definitions in a data processing cluster in accordance with the disclosed embodiments.

FIG. 3B shows a flowchart illustrating an exemplary process of automatically addressing inefficient job definitions in a data processing cluster in accordance with the disclosed embodiments.

FIG. 4 shows a flowchart illustrating an exemplary process of calculating inefficiency metrics for jobs in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system for finding and addressing sub-optimal job configurations within a software framework for processing large data sets. More specifically, the disclosed embodiments provide a method, apparatus, and system that: (1) rates the inefficiency of one or more jobs within the software framework, (2) ranks the jobs based on their inefficiency ratings, (3) and performs one or more actions with regard to the most inefficient jobs within the ranking to improve the data processing cluster's latency and/or throughput.

Web companies often provide web-based services and applications that deal with very large data sets. To process such data sets, a web company may use a software framework (e.g., Hadoop) that can divide a large processing job (e.g., a job) into a plurality of smaller tasks (i.e., tasks) that may be processed in parallel by individual machines within one or more data processing clusters of the software framework.

Because users (i.e., developers) write and configure jobs (i.e., developers write job definitions), some jobs may not be optimally configured. In some cases, sub-optimally configured jobs may occupy an excessive amount of the cluster's resources, wasting the resources and blocking and/or interfering with the execution of other jobs, thereby reducing the framework's rate at which jobs are completed. The disclosed embodiments may provide a system for automatically detecting and/or addressing sub-optimally configured jobs, which may preserve and/or improve the software framework's latency and throughput.

During operation, one or more jobs, which are scheduled to execute within a data processing cluster for processing large data sets on behalf of one or more applications, are completed over a time period. Next, a job auditor (e.g., a process executed by a server alongside and/or within the data processing cluster) calculates an inefficiency metric for each of the completed jobs, wherein the inefficiency metric for a job may be based on metadata pertaining to the job's execution. The job auditor may then rank the completed jobs based on their inefficiency metrics and select a number of the top-ranked jobs from the ranking. Next, the job auditor may aggregate the top-ranked jobs into one or more job definitions that correspond with the top-ranked jobs. Because (1) jobs are essentially scheduled executions of job definitions, and (2) the one or more job definitions are associated with the most inefficient jobs, the job auditor may conclude that each of the selected job definitions is sub-optimal (e.g., the job definition spawns jobs that request far more resources than actually used) and needs to be optimized. In response, the job auditor may take one or more actions to correct each of the sub-optimal job definitions (e.g., open a ticket that informs the job definition's user that the job definition is sub-optimal).

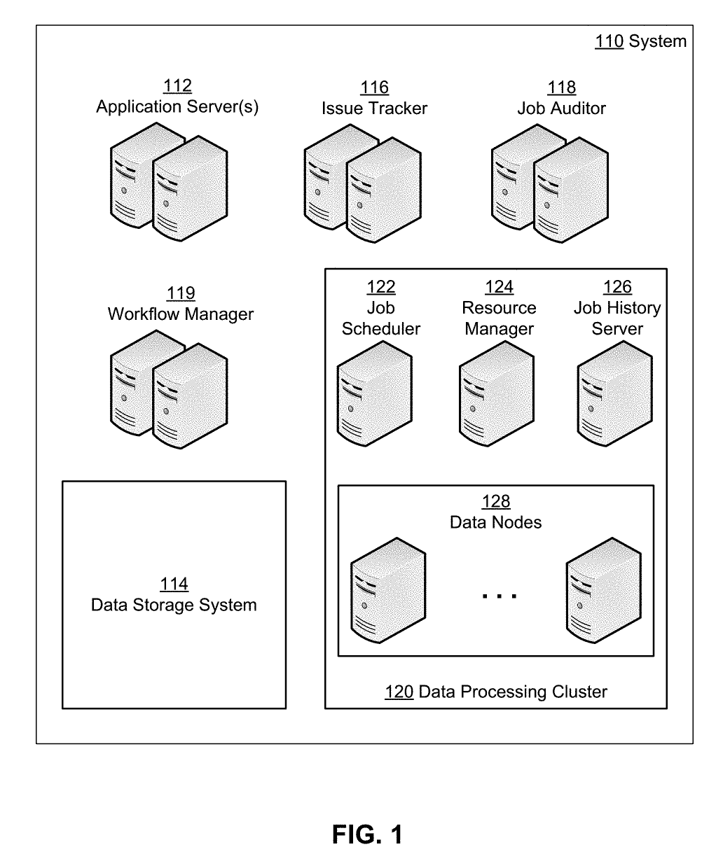

FIG. 1 shows a schematic of a system in accordance with the disclosed embodiments. As shown in FIG. 1, system 110 is (or is part of) a data center and includes different components in different embodiments. In the illustrated embodiments, the system includes application server(s) 112 for hosting one or more applications and/or web services, data storage system 114 (e.g., a distributed storage system that includes one or more data storage devices and/or components) for storing data used by server(s) 112 and/or other components of system 110, issue tracker 116, job auditor 118, workflow manager 119, and data processing cluster 120.

Data processing (or computational) cluster 120 supports the distributed processing of data, especially very large data sets. In illustrative embodiments, cluster 120 includes at least one name node that manages the name space of a file system or file systems distributed across data nodes 128, of which there may be tens, hundreds, or thousands. Each data node 128 includes one or more types of data storage devices (e.g., memory, solid state drives, disk drives).

Jobs (e.g., Hadoop jobs) submitted to the cluster are divided and/or partitioned into any number of tasks, which are distributed among the data nodes for processing. When executed, the job may spawn one or more mapper tasks that process (raw) data, and (oftentimes) a set of reducer tasks that process the output of the mapper tasks. Each task may be executed within a container that provides a virtualized environment (e.g., such as a Java Virtual Machine (JVM), Java™ is a registered trademark of Oracle America, Inc.) in which instructions (e.g., high level code, bytecode, native machine code) contained in the job may execute. The amount of memory allocated for a container (e.g., the container size) may be specified by the job that spawned the container's task. The total amount of available memory for the data processing cluster may limit the number of containers that can concurrently execute tasks. For example, if the data processing cluster has 24 gigabytes (GB) of available memory in total, up to 12 mapper tasks and/or reducer tasks can be concurrently executed (assuming each task is run in a 2 GB container). It should be noted that an improperly configured job may spawn tasks that request much more memory than it uses. For example, a job that requests a 2 GB container but only uses up to 800 MB of memory within the container at any one point ties up an extra 1200 MB of the data processing cluster's memory, which may potentially reduce the number of tasks that the cluster can run concurrently.

In some embodiments, the cluster may receive jobs from workflow manager 119. Workflow manager 119 (e.g., Azkaban) may provide one or more tools that enable developers to create job definitions (e.g., Azkaban jobs) using a programming language (e.g., Java). Each job definition defines one or more processing actions within the software framework. Additionally, a job definition may be configured by its developer to execute multiple times over a time period.

Here, an execution of a job definition may correspond to a job (e.g., Hadoop job) that is submitted by the workflow manager to job scheduler 122. Thus, a single job definition may be associated with one or more jobs that have already executed in the cluster and/or one or more jobs that are waiting to be executed in the cluster. Additionally, a developer may further assemble multiple job definitions into flows (e.g., Azkaban flows) in order to handle job definitions that have various dependencies between each other. For example, if a first job definition is dependent on the execution of a second job definition, a developer may create a flow that executes the second job definition and then the first job definition in sequence.

Resource manager 124 assigns jobs and/or the tasks spawned on behalf of the jobs to individual data nodes 128. Each data node executes management logic (e.g., an application master, a node manager) for scheduling and executing tasks. The resource manager and/or individual data nodes may track the usage of resources during execution of jobs/tasks (e.g., execution time, processor time, memory, disk space, communication bandwidth). Resource manager 124 may therefore be termed a Job Tracker because it tracks the completion of jobs received at cluster 120 (e.g., from users, clients), and individual data nodes may be termed Task Trackers for their roles in tracking completion of their assigned tasks.

Job history server 126 may encompass one or more servers that obtain, calculate, and/or store metadata pertaining to jobs that have finished executing within cluster 120. This metadata may be used to calculate inefficiency metrics for the finished jobs.

Issue tracker 116 may correspond to project management software that uses tickets to track issues and/or bugs (e.g., JIRA).

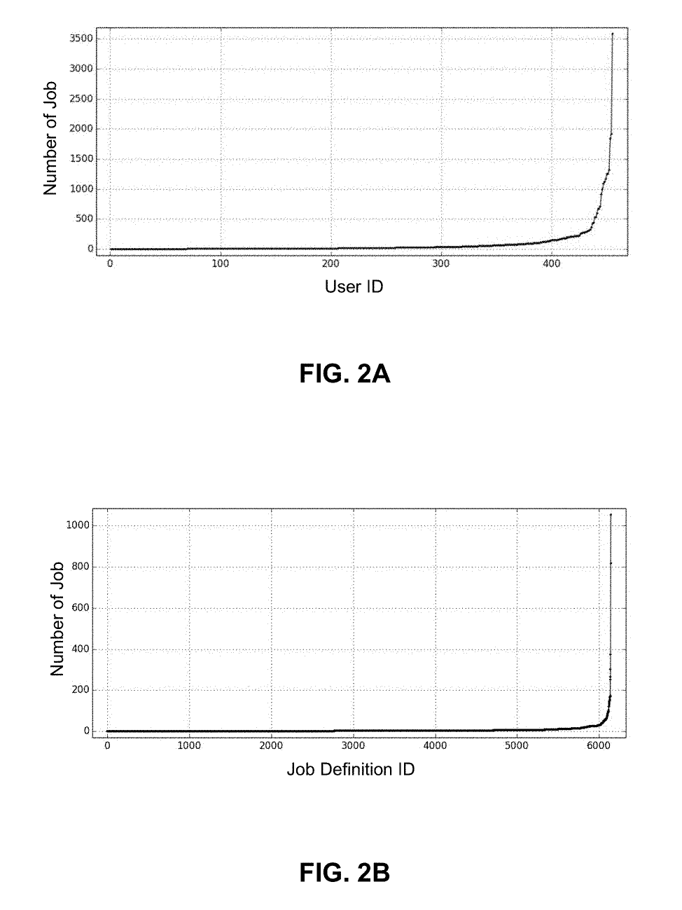

Job auditor 118 may include one or more servers that execute processes for automatically detecting and/or addressing inefficient jobs inside data processing cluster 120. Job auditor 118 may run periodically (e.g., once a week). The job auditor is discussed in further detail below with respect to FIGS. 2-5.

FIGS. 2A-B show a couple of graphs that illustrate a hypothetical set of statistics captured over 24 hours from data processing cluster 120. FIG. 2A shows a graph that illustrates the relationship between users and jobs submitted by the users over a single day in accordance with the disclosed embodiments. As shown in FIG. 2A, 455 unique users (each identified by a unique user ID, such as a Lightweight Directory Access Protocol (LDAP) user ID) have each caused at least one job (via writing a job definition) to be scheduled for execution in the data processing cluster during the 24 hours. In total, 38740 jobs have been scheduled to execute during the 24 hours. As shown in the extreme right of the graph, the user that is associated with the highest number of jobs is associated with over 3500 jobs while, on average, each user is associated with 22 jobs.

FIG. 2B shows a graph that illustrates the relationship between job definitions and their corresponding jobs in accordance with the disclosed embodiments. As shown in FIG. 2B, more than 6000 unique job definitions (each identified by a unique job definition ID) have each scheduled to execute at least once in the data processing cluster during the 24 hours. The sum of all job definition executions equals 38740 executions. As shown in the extreme right of the graph, the job definition that executed the most times during the 24 hours executed over 1000 times.

As can be seen from the two graphs, a single user may be responsible for maintaining one or more job definitions. In turn, a single job definition that is configured to execute repeatedly may cause a plurality of jobs to be scheduled in the data processing cluster. It should also be noted that the majority of jobs scheduled within the cluster may be traced back to a relatively small group of job definitions. If one or more of these job definitions were configured to execute inefficiently, the data processing cluster's latency and throughput could degrade significantly. Thus, to ensure that the data processing cluster continues to run smoothly, it is important to periodically search for and address the cluster's most inefficient jobs.

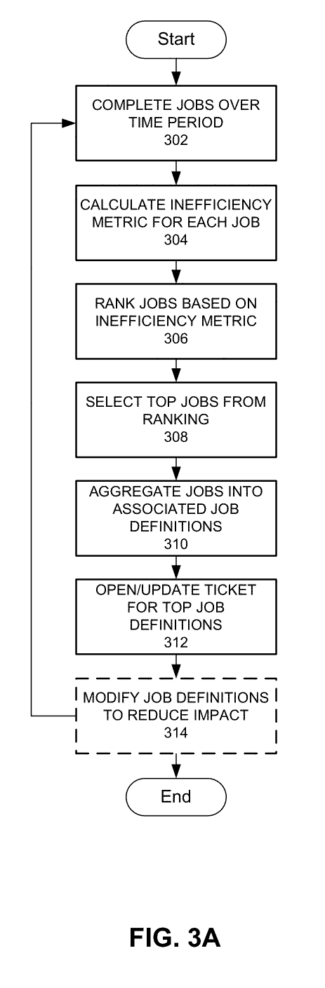

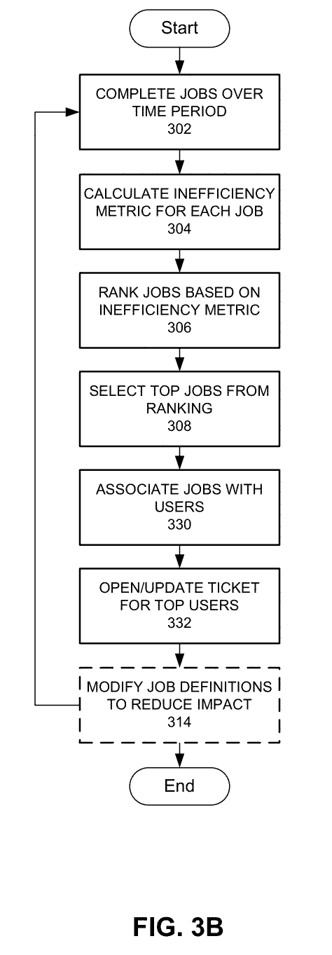

FIG. 3A shows a flowchart illustrating an exemplary process of automatically addressing inefficient job definitions in a data processing cluster in accordance with the disclosed embodiments. In one or more embodiments, one or more of the steps may be omitted, repeated, and/or performed in a different order. Accordingly, the specific arrangement of steps shown in FIG. 3A should not be construed as limiting the scope of the embodiments.

As shown in the flowcharts, the job auditor periodically (e.g., once a week) executes a process to find and address inefficient jobs in a data processing cluster as the cluster continues to execute jobs.

FIG. 3A shows a job-centric variation of the process. First, a data processing cluster completes one or more jobs within a time period between executions of the job auditor (operation 302). When a job completes, a job history server may record metadata pertaining to the job's execution. Each and every job execution may be uniquely identified within the job history server with a Job ID. Each time a job finishes executing within cluster 120, the job history server may store metadata pertaining to the finished job. The metadata for a particular job may include: (1) the number of mapper tasks spawned by the job, (2) the number of reducer tasks spawned by the job, (3) the size of output data from each mapper task and reducer task associated with the job, (4) time spent by the container's virtual machine in garbage collection time for each mapper task and reducer task, (5) execution time of each mapper task and reducer task, (6) the average amount of memory used by each mapper task and reducer task, (7) the maximum amount of memory used by each mapper task and reducer task, and/or (8) the amount of memory allocated (e.g., container size) by each mapper task and reducer task. In other embodiments, different metadata may be stored.

In some embodiments, system 110 may additionally include one or more auxiliary processes (e.g., Dr. Elephant) that use retrieved metadata from job history server 126 to generate preliminary metrics pertaining to the efficiency of finished jobs. For a particular job, the preliminary metrics may include: (1) how equally the job's data is distributed amongst the job's mapper tasks (i.e., data skewness), (2) how quickly the mapper tasks execute (i.e., mapper task execution time), and (3) how efficiently the mapper tasks use the memory they have been assigned. Furthermore, the auxiliary processes may rate each of the preliminary metrics on a scale of 0-4 (i.e., none to critical) wherein a higher score corresponds to a less efficient preliminary metric. The preliminary metrics for a job may also be aggregated into a single overall efficiency rating of the job, which may also be on a scale of 0-4. These ratings may then be stored for later use.

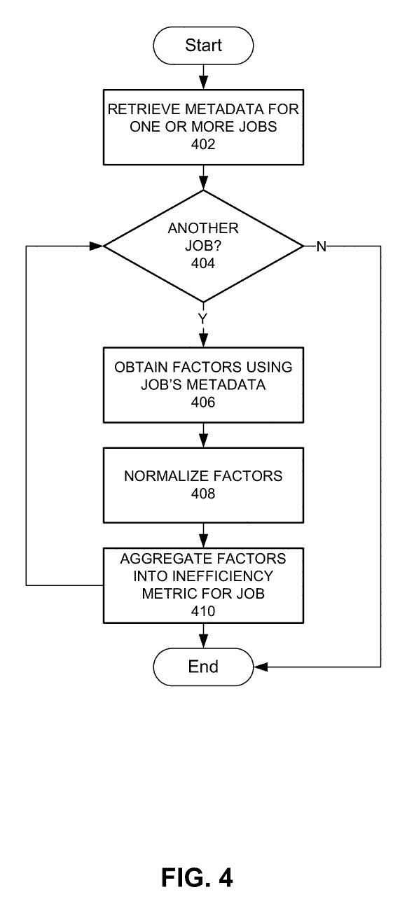

When the time period ends, the job auditor restarts the process for finding and addressing inefficient jobs within the cluster. Here, the job auditor calculates an inefficiency metric for each job that completed during the time period (operation 304). To calculate the metrics, the job auditor may rely on metadata retrieved from the data processing cluster's job history server as well as the preliminary metrics and/or ratings calculated above. The process of calculating an inefficiency metric for each job is discussed in further detail below with respect to FIG. 4.

Once the inefficiency metrics have been calculated, the job auditor ranks all of the jobs (including jobs that executed prior to the time period) in descending order based on their inefficiency metrics (operation 306). Next, the job auditor selects the top M jobs from the ranking (operation 308). Initially, M might be a small number (e.g., 100). After several runs of the job auditor, M may be incrementally scaled up to a higher number to automatically detect and address higher numbers of inefficient jobs and further optimize the data processing cluster.

Next, the job auditor aggregates the M jobs into N associated job definitions (operation 310). For example, if there are five jobs that executed within the time period that are defined by a particular job definition (i.e., each of the five jobs is an execution of the job definition), the five jobs may be aggregated into the job definition. In doing so, the job auditor selects the job definitions that have had the most severe impact on the data processing cluster's latency and throughput. Because a job is equivalent to an execution of a job definition and because a single job definition may execute multiple times within the time period, N may be a smaller number than M. The aggregation may be performed in various ways. In some embodiments, associated job definitions may be selected by the job auditor. Alternatively, the metrics for each job that is associated with a job definition may be aggregated (e.g., added together, averaged together) into a single metric for the job definition.

The job auditor then opens or updates a ticket at an issue tracker for at least some of the job definitions (operation 312). In some embodiments, the job auditor may open and/or update a ticket for each of the job definitions found in the previous step. Alternatively, the number of tickets that the job auditor may open for each period may be limited to a number P, which may be a preconfigured number (e.g., 20). In some embodiments, the number of jobs M selected from the ranking may be a multiple of P (e.g., a maximum of 100 jobs are selected from the ranking but only a maximum number of 20 tickets can be opened). If M is larger than P, the job definitions that were found in the previous step may themselves be ranked by severity (e.g., in some embodiments, using metrics of the job definitions), wherein the job auditor opens/updates tickets for only the top P job definitions. In an alternative embodiment, the number of tickets that may be open within the issue tracker at any time may be limited to P (e.g., if P=20 and 15 tickets are already open, the maximum number of tickets that can be opened for the latest period is 5).

To determine whether a ticket should be opened or updated for a job definition, the job auditor may first determine whether a ticket that is associated with the job definition already exists. Here, each ticket may be uniquely identified by the job definition's ID, which may be the job definition's name or a uniform resource locator (URL) associated with the job definition. If a ticket that is associated with the job definition does not yet exist, the job auditor creates a ticket with the job definition's ID. If a ticket already exists, the ticket is updated with a reference (e.g., link) to the latest execution (i.e., job) of the job definition. If a ticket already exists and the ticket is closed, the job auditor may reopen and update the ticket with new information (e.g., details and URLs associated with the latest execution of the job definition, updated resource usage statistics pertaining to the job definition). In response to each opened/updated ticket, the issue tracker may send a notification (e.g., an email) to a user that is responsible for maintaining the job definition associated with the ticket. Once the notification is received by the user, the user may proceed to fix and/or optimize the job definition and close the ticket.

In some embodiments, multiple tickets may be opened for a single job definition, wherein each ticket focuses on a particular type of inefficiency found in the job definition. For example, if a particular job definition has three different inefficiencies (e.g., inefficiency in mapper task memory usage, inefficiency in reducer task memory usage, garbage-collection inefficiency), three separate tickets could be opened for the job definition. This approach may provide more granularity with regard to tracking progress on addressing the particular job definition. For example, if garbage collection inefficiency of the job definition is addressed, the ticket that focuses on the garbage-collection inefficiency for the job definition can be closed, thereby indicating that progress has been made in addressing the job definition as a whole.

A ticket may include actionable information pertaining to the job definition, such as: (1) one or more URLs associated with the job definition, (2) a list of the job definition's past executions (i.e., jobs), (3) an indication of the amount of resources that the job definition is wasting, (4) a number of jobs/executions associated with the job definition, (5) a number of mapper tasks associated with the job definition, (6) the total number of reducer tasks associated with the job definition, (7) the job definition's total resource usage, (8) one or more preliminary ratings associated with executions of the job definition that were generated by the one or more auxiliary processes, (9) data skewness (i.e., how balanced is the distribution of data to mapper tasks), and (10) execution times of the jobs associated with the job definition. In some embodiments, the ticket may additionally include suggestions on how to optimize the job definition.

FIG. 3B shows a flowchart illustrating an exemplary process of automatically addressing inefficient job definitions in a data processing cluster in accordance with the disclosed embodiments. In one or more embodiments, one or more of the steps may be omitted, repeated, and/or performed in a different order. Accordingly, the specific arrangement of steps shown in FIG. 3B should not be construed as limiting the scope of the embodiments.

FIG. 3B shows a user-centric variation of the process shown in FIG. 3A, and the illustrated method includes operations 304 through 308, which are discussed above. In this variation, after the top M jobs of the job ranking are selected or identified, the job auditor associates the M jobs with O users by first aggregating the jobs into N associated job definitions and then associating the N job definitions with O users (operation 330), which are the users that maintain the N job definitions. Because a user may maintain multiple job definitions, O may be a smaller number than N.

The job auditor then opens or updates a ticket at the issue tracker for at least some of the users (operation 332). In some embodiments, the job auditor may open and/or update a ticket for each of the users found in the previous step. In another embodiment, the job auditor may be limited to opening/updating job definitions for the top P users if O is larger than P. In this approach, tickets opened at the issue tracker may: (1) reference multiple job definitions, (2) contain information pertaining to multiple job definitions and their executions, and (3) be uniquely identified by a user ID. Likewise, one or more notifications sent by the issue tracker may reference multiple job definitions and be sent to a user associated with the user ID. One advantage of the user-centric approach is that fewer tickets need to be maintained if at least one user is responsible for maintaining more than one of the job definitions.

It should be noted that in the methods shown in both FIG. 3A and FIG. 3B, in addition to opening tickets, the job auditor may take additional steps to reduce the impact of the most inefficient job definitions on the data processing cluster (optional operation 314). For example, if the job auditor determines that a particular job definition requests a container size that is much larger than the amount of memory used by the tasks that are spawned by its jobs (i.e., the requested amount of memory per task is larger than the maximum amount of memory used by any task), the job auditor may automatically modify the job definition to request a smaller container size. Also, or instead, if the job auditor determines that jobs of a particular job definition take a long time to complete due to the jobs not receiving enough resources to operate efficiently (e.g., the job definition specifies a container size that is too small, the job definition uses too few mapper tasks to process a large data set), the job auditor may automatically modify the job definition so that its jobs are no longer blocked by the resource shortage (e.g., the job definition is modified to request larger container sizes, the job definition is modified to use a larger number of mapper tasks).

FIG. 4 shows a flowchart illustrating an exemplary process of calculating inefficiency metrics for jobs in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

To calculate inefficiency metrics for each job that completed during the time period (e.g., as part of operation 304 shown in FIGS. 3A-3B), the job auditor may retrieve metadata for each of the jobs (operation 402). This metadata may include information stored by the job history server and preliminary metrics calculated by the one or more auxiliary processes. Next, the job auditor uses the metadata to generate an inefficiency metric for each of the jobs. First, if there are more jobs for which an inefficiency metric needs to be generated (decision 404), the job auditor selects the next job's metadata. To obtain an inefficiency metric for the job, the job auditor may obtain and/or calculate a set of factors using the metadata (operation 406).

The set of factors may include a measure of resources allocated to the job. One of the resources may include the job's memory usage over time. If executing a job definition tends to tie up a large amount of resources, any inefficiency inherent in the job definition may be magnified and the case for optimizing the associated job definition may be stronger. In some embodiments, the job's memory usage over time may be calculated by finding the product of the job's execution time and the job's memory usage, which has the unit of megabytes (MB)*seconds (sec). The job's execution time may correspond to the amount of time where the job has at least one task being executed by the cluster. The job's memory usage may correspond to the sum of the container sizes of all tasks spawned by the job. Another way of determining the job's memory usage over time includes: (1) finding, for each task that is spawned by the job, the product of the task's execution time and the task's container size, and (2) summing the products.

In some embodiments, the measure of the resources allocated to the job may include an amount of processor time devoted to the job's tasks and/or an amount of input/output (I/O) performed by the tasks.

The set of factors may additionally include a measure of how efficiently the job used the allocated resources. Even if a job occupies a large amount of resources, there may be no point in optimizing a job definition if its executions are already efficient. In some embodiments, this measure may be associated with the container sizes of the job's tasks and the amount of memory used by the tasks. To obtain this measure, the sum of all container sizes of the tasks may be divided by the sum of the amounts of memory used by the tasks. For example, if a job spawned a total of two tasks each with a container size of 2 GB, and both tasks used only 1 GB, the resulting measure would be equal to (2 GB+2 GB)/(1 GB+1 GB)=2. The amount of memory used by a task may correspond to a maximum amount of memory used by the task throughout its execution or an average amount of memory used by the task during its execution.

The set of factors may include the frequency with which the job and other jobs that share the same job definition executed throughout the time period. If a job definition executes often, any inefficiency inherent in the job definition may be magnified. In some embodiments, the frequency may be determined by finding all jobs within the time period that reference the same job definition ID as the current job.

The set of factors may include a measure of how consistently the job performs. Because the execution environment provided by the data processing cluster and input data may be dynamic, executions of the same job definition may vary greatly over time. Here, if a job definition tends to execute inefficiently (e.g., by using allocated resources inefficiently) only once in awhile (e.g., only one out of a hundred executions is found to be inefficient), the case for optimizing the job definition may be weaker. Hence, the set of factors may include inefficiency-related measurements obtained from other jobs completed in the same time period (or outside the time period) that reference the same job definition as the current job.

After the set of factors is obtained from the job's metadata, the job auditor may normalize each of the factors using a function (operation 408). In some embodiments, the function may be an exponential decay function. For example, the function may be

$$f = {e}^{- \frac{B}{V}} ,$$

wherein V is the value of the factor for this job and B is the average value of the factor for all jobs during the time period. The decay function maps any value to a [0, 1] zone, which normalizes the factor.

Next, the job auditor aggregates the normalized factors into an inefficiency metric for the job (operation 410), wherein a higher inefficiency metric may correspond to a more inefficient job. In the illustrated embodiments, aggregating the factors involves adding the factors together into a single value, but may be performed in some other manner in other embodiments. Once the inefficiency metric has been calculated for the job, the job auditor moves on to the next job. Once all jobs within the time period have had their inefficiency metrics calculated, the job auditor may rank the jobs using their inefficiency metrics.

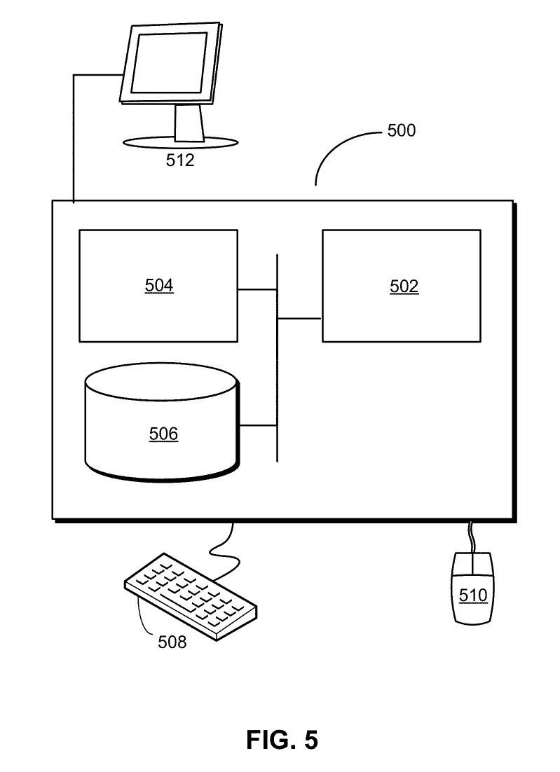

FIG. 5 shows a computer system 500 in accordance with an embodiment. Computer system 500 may correspond to an apparatus that includes a processor 502, memory 504, storage 506, and/or other components found in electronic computing devices such as personal computers, laptop computers, workstations, servers, mobile phones, tablet computers, and/or portable media players. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software linker provided by the operating system.

In one or more embodiments, computer system 500 provides a system for automatically detecting and addressing inefficient job definitions that execute at a software framework for processing large data sets. The system may include a job auditor apparatus that periodically executes to find the job definitions that are most severely degrading the software framework's latency and throughput with regard to job completion by analyzing job history metadata stored at a job history server of the software framework's data processing cluster.

In addition, one or more components of computer system 500 may be remotely located and connected to the other components over a network. Portions of the present embodiments (e.g., storage apparatus, extraction apparatus, etc.) may also be located on different nodes of a distributed system that implements the embodiments. For example, the present embodiments may be implemented using a cloud computing system that improves the knowledge and management of memory consumption in a set of remote software programs.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method, comprising:
for each of a plurality of jobs executed by a computing system component, wherein each job comprises an execution of a corresponding job definition:
retrieving metadata about the job from the computing system component; and
calculating an inefficiency metric for the job based on the metadata, wherein a higher inefficiency metric corresponds to a more inefficient job;
ranking the plurality of jobs based on each job's inefficiency metric and selecting one or more top-ranked jobs from the ranking;
selecting one or more job definitions corresponding to the one or more top-ranked jobs; and
sending optimization requests to users associated with the selected job definitions.

2. The computer-implemented method of claim 1, wherein:
the computing system component is a data processing cluster that executes logic to:
receive jobs submitted by users; and
for each submitted job:
execute one or more associated tasks to complete the job; and
store metadata about the job; and
the data processing cluster comprises:
multiple data nodes that execute the tasks associated with the submitted jobs;
a first node managing a namespace encompassing the multiple data nodes;
a second node scheduling the tasks to data nodes; and
a third node for storing the job metadata.

3. The computer-implemented method of claim 1, wherein sending optimization requests to users associated with the selected job definitions comprises:
for each of the selected job definitions:
if a ticket exists for the job definition, updating the ticket at an issue tracking server; and
if a ticket does not exist for the job definition, opening a ticket for the job definition at the issue tracking server; and
wherein a ticket for a job definition comprises metadata about at least one job that executed the job definition during the time period.

4. The computer-implemented method of claim 1, wherein sending optimization requests to users associated with the selected job definitions comprises:
for each user associated with at least one of the selected job definitions, opening a single ticket for the user, wherein the single ticket references all job definitions associated with the user.

5. The computer-implemented method of claim 1, wherein calculating the inefficiency metric for a given job based on the metadata comprises:
obtaining one or more factors about the given job from the metadata;
normalizing each of the one or more factors to share a same scale; and
aggregating the one or more factors to yield the inefficiency metric.

6. The computer-implemented method of claim 5, wherein the one or more factors comprise at least one of:
a measure of resources allocated to the given job;
a measure of how efficiently the given job used the allocated resources;
a frequency with which the given job was executed during the time period; and
for each other job aside from the given job that executed the job definition during the time period, a measure of how efficiently the other job used the resources that were allocated by the other job.

7. The computer-implemented method of claim 6, wherein the allocated resources comprise at least one of:
an amount of memory allocated to the job; and
an amount of central processing unit (CPU) processing allocated to the job.

8. The computer-implemented method of claim 7, wherein the measure of how efficiently the given job used the allocated resources is determined by:
calculating a ratio between the amount of memory allocated by the job and a maximum amount of memory used by the job at any one time; or
calculating a ratio between the amount of memory allocated by the job and an average amount of memory used by the job over the duration of the job.

9. The computer-implemented method of claim 1, wherein the metadata comprises at least one of:
a number of mapper tasks associated with the job;
a number of reducer tasks associated with the job;
an amount of memory allocated by each of the mapper tasks and reducer tasks associated with the job;
a maximum amount of memory used by each of the mapper tasks and reducer tasks associated with the job; and
an average amount of memory used by each of the mapper tasks and reducer tasks associated with the job.

10. The computer-implemented method of claim 1, wherein the method further comprises for at least one of the selected job definitions:
identifying a specific inefficiency in the job definition using metadata associated with one or more jobs corresponding to the job definition; and
modifying the job definition to alleviate the specific inefficiency.

11. The computer-implemented method of claim 10, wherein:
the specific inefficiency comprises each of the one or more jobs associated with the job definition being allocated more memory than a maximum amount of memory used by any of the one or more jobs corresponding to the job definition; and
the modification comprises modifying a configuration associated with the job definition to specify a smaller amount of memory to be allocated.

12. An apparatus, comprising:
one or more processors; and
memory storing instructions that, when executed by the one or more processors, cause the apparatus to:
for each of a plurality of jobs executed by a computing system component, wherein each job comprises an execution of a corresponding job definition:
retrieve metadata about the job from the computing system component;
calculate an inefficiency metric for the job based on the metadata, wherein a higher inefficiency metric corresponds to a more inefficient job;
rank the plurality of jobs based on each job's inefficiency metric and select one or more top-ranked jobs from the ranking;
select one or more job definitions corresponding to the one or more top-ranked jobs; and
send optimization requests to users associated with the selected job definitions.

13. The apparatus of claim 12, wherein:
the computing system component is a data processing cluster that executes logic to:
receive jobs submitted by users; and
for each submitted job:
execute one or more associated tasks to complete the job; and
store metadata about the job; and
the data processing cluster comprises:
multiple data nodes that execute the tasks associated with the submitted jobs;
a first node managing a namespace encompassing the multiple data nodes;
a second node scheduling the tasks to data nodes; and
a third node for storing the job metadata.

14. The apparatus of claim 12, wherein sending optimization requests to users associated with the selected job definitions comprises:
for each of the selected job definitions:
if a ticket exists for the job definition, updating the ticket at an issue tracking server; and
if a ticket does not exist for the job definition, opening a ticket for the job definition at the issue tracking server; and
wherein a ticket for a job definition comprises metadata about at least one job that executed the job definition during the time period.

15. The apparatus of claim 12, wherein sending optimization requests to users associated with the selected job definitions comprises:
for each user associated with at least one of the selected job definitions, opening a single ticket for the user, wherein the single ticket references all job definitions associated with the user.

16. The apparatus of claim 12, wherein calculating the inefficiency metric for a given job based on the metadata comprises:
obtaining one or more factors about the given job from the metadata;
normalizing each of the one or more factors to share a same scale; and
aggregating the one or more factors to yield the inefficiency metric.

17. The apparatus of claim 16, wherein the one or more factors comprise at least one of:
a measure of resources allocated to the given job;
a measure of how efficiently the given job used the allocated resources;
a frequency with which the given job was executed during the time period; and
for each other job aside from the given job that executed the job definition during the time period, a measure of how efficiently the other job used the resources that were allocated by the other job.

18. The apparatus of claim 17, wherein the allocated resources comprise at least one of:
an amount of memory allocated to the job; and
an amount of central processing unit (CPU) processing allocated to the job.

19. The apparatus of claim 18, wherein the measure of how efficiently the given job used the allocated resources is determined by:
calculating a ratio between the amount of memory allocated by the job and a maximum amount of memory used by the job at any one time; or
calculating a ratio between the amount of memory allocated by the job and an average amount of memory used by the job over the duration of the job.

20. One or more non-transitory computer-readable storage media storing instructions that when executed by a computer cause the computer to perform a method, the method comprising:
for each of a plurality of jobs executed by a computing system component, wherein each job comprises an execution of a corresponding job definition:
retrieving metadata about the job from the computing system component;
calculating an inefficiency metric for the job based on the metadata, wherein a higher inefficiency metric corresponds to a more inefficient job;
ranking the plurality of jobs based on each job's inefficiency metric and selecting one or more top-ranked jobs from the ranking;
selecting one or more job definitions corresponding to the one or more top-ranked jobs; and
sending optimization requests to users associated with the selected job definitions.
